(19) United States
(12) Patent Application Publication
(10) Pub. No.: US 2025/0370102 A1
(43) Pub. Date: Dec. 4, 2025

(54) DETECTION OF AN OBSCURANT ON AN ENVIRONMENT SURFACE BY A LIDAR SYSTEM

(71) Applicant: Luminar Technologies, Inc., Orlando, FL (US)

(72) Inventors: Prateek Mehrotra, Santa Clara, CA (US); Amey Sutavani, Sunnyvale, CA (US); Anton Sotnikov, Mountain View, CA (US)

(21) Appl. No.: 19/202,256

(22) Filed: May 8, 2025

Related U.S. Application Data
(60) Provisional application No. 63/652,533, filed on May 28, 2024.

(51) Int. Cl. G01S 7/48; G01S 7/481; G01S 7/4865; G01S 7/487; G01S 7/497; G01S 17/86; G01S 17/89; G01S 17/931

(52) U.S. Cl. CPC G01S 7/4802; G01S 7/4817; G01S 7/4865; G01S 7/4873; G01S 7/497; G01S 17/86; G01S 17/89; G01S 17/931; G01S 2007/4975

(57) ABSTRACT

In various embodiments, a system for detecting an obscurant on an environment surface includes a light source; a scanner; a receiver that detects scattered reflection returns, some of which may be below a detection threshold; and a processor. The processor determines whether the portion below the threshold corresponds to an obscurant on an environment surface, including by: receiving a new point cloud including a group of points corresponding to the environment surface, clustering at least a portion of the group of points to form a projected shape, and clustering into a candidate cluster at least a portion of the portion below the threshold that belong to projected locations within the shape. The obscurant candidate cluster is compared with a previously determined cluster to determine whether a detected change conforms to a detected physical movement of the system. If so, the obscurant candidate cluster is an obscurant on the environment surface.

### CROSS REFERENCE TO OTHER APPLICATIONS

This application claims priority to U.S. Provisional Patent Application No. 63/652,533 entitled DETECTION OF AN OBSCURANT ON AN ENVIRONMENT SURFACE BY A LIDAR SYSTEM filed May 28, 2024 which is incorporated herein by reference for all purposes.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light towards a target which scatters the light, and some of the scattered light is received back at the receiver. The system determines the distance to the target based on one or more characteristics associated with the received light. The determined distance to the target may be helpful for mapping an environment and planning a trip. However, sometimes the light source emits light towards a target, but receives no return. This may happen due to a variety of causes including an obscurant on an environment surface. Thus, there is a need to detect an obscurant on the environment surface, which would also improve the accuracy of mapping and trip planning, among other things.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOV_{L}) and receiver field of view (FOV_{R}) for a lidar system.

FIG. 5 illustrates an example unidirectional scan pattern that includes multiple pixels and multiple scan lines.

FIG. 6 is a flow diagram illustrating an embodiment of a process for detecting an obscurant on an environment surface.

FIG. 7 is a flow diagram illustrating an embodiment of a process for fingerprinting returns to classify absorbing targets.

FIG. 8 shows an example of an obscurant on an environment surface.

FIG. 9 shows an example of a blockage map.

FIG. 10 shows an example of a projected shape obtained in some embodiments.

FIG. 11 shows an example of another projected shape obtained in some embodiments.

FIG. 12 shows an example of an obscurant candidate cluster obtained in some embodiments.

FIG. 13 shows an example of an obscurant candidate cluster in a first frame obtained in some embodiments.

FIG. 14 shows an example of an obscurant candidate cluster in a second frame obtained in some embodiments.

FIG. 15 shows an example of using a Kalman filter to perform a comparison of an obscurant candidate cluster with a previously determined obscurant candidate cluster.

FIG. 16 illustrates an example computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques for detecting an obscurant on an environment surface by a lidar system are disclosed. An absorbing obscurant, such as a puddle of water on a drivable surface, may be detected by a lidar system. As further described herein, a lidar system emits an output beam. Typically, the system receives a return beam that has an associated blockage level. However, in some instances, the system does not receive a return beam. The absence of a return beam (sometimes referred to as an “empty ray”) may be caused by free space loss, a purely-absorbing blockage on the lidar system such as a blockage on a window of the lidar system, or a target that fully absorbs the emitted beam. Conventional techniques are typically unable to effectively and efficiently detect or determine an obscurant in the environment that fully absorbs an emitted beam.

The disclosed techniques effectively and efficiently detect an obscurant on an environment surface by characterizing a cluster of empty rays, detecting physical movement, and determining whether the cluster of empty rays changes over time as expected for the detected physical movement. A cluster of empty rays may be characterized by analyzing a point cloud or depth map. For example, a plurality of frames of projected depth map points (sometimes simply called “projections”) is processed to identify an obscurant candidate cluster, which is a cluster of empty rays. If the obscurant candidate cluster moves as expected for the detected physical movement, then this indicates that there is an obscurant on the environment surface. A puddle on a road would be expected to move forwards or backwards on the projection.

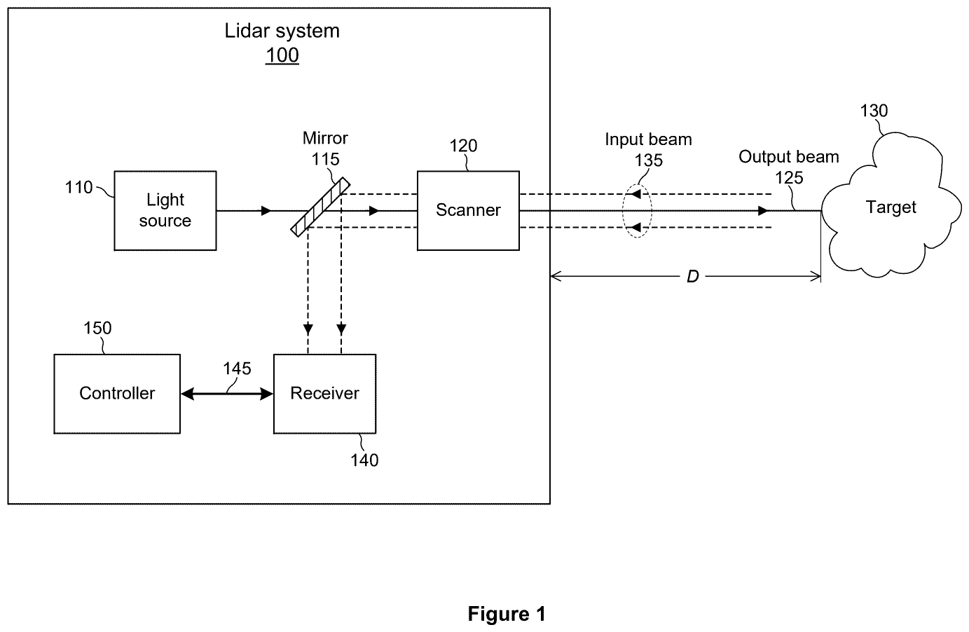

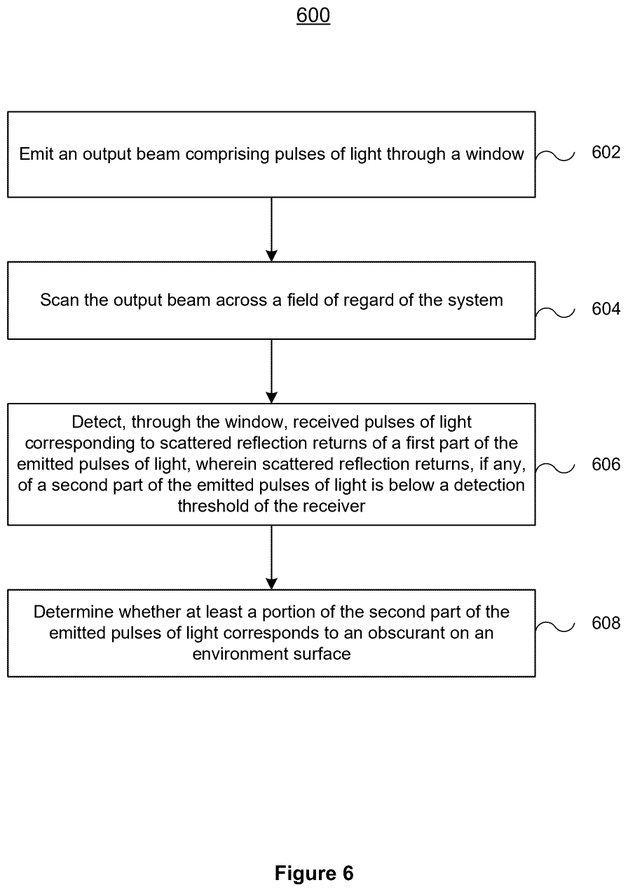

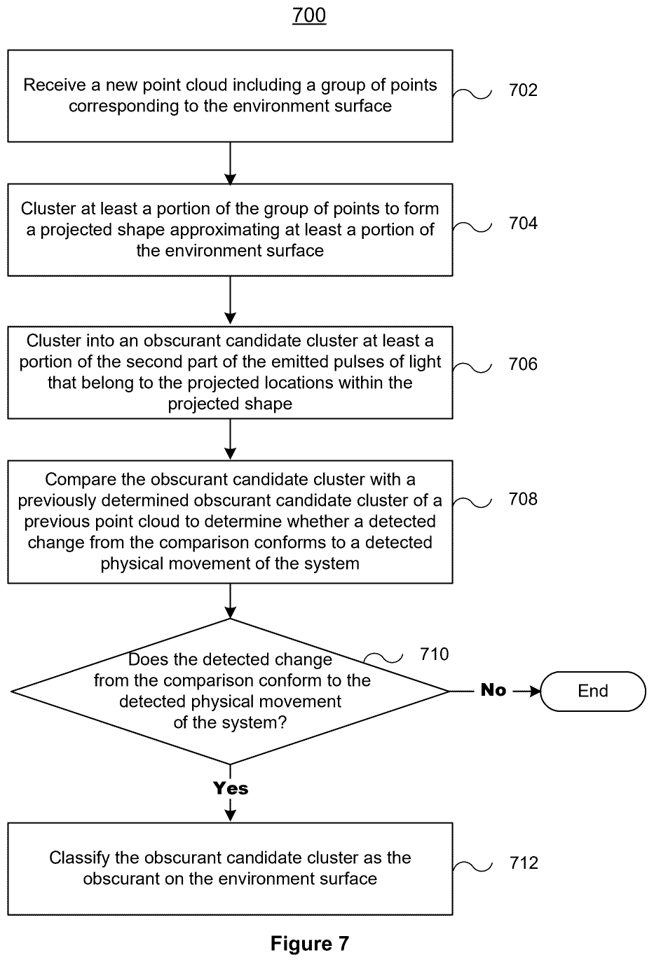

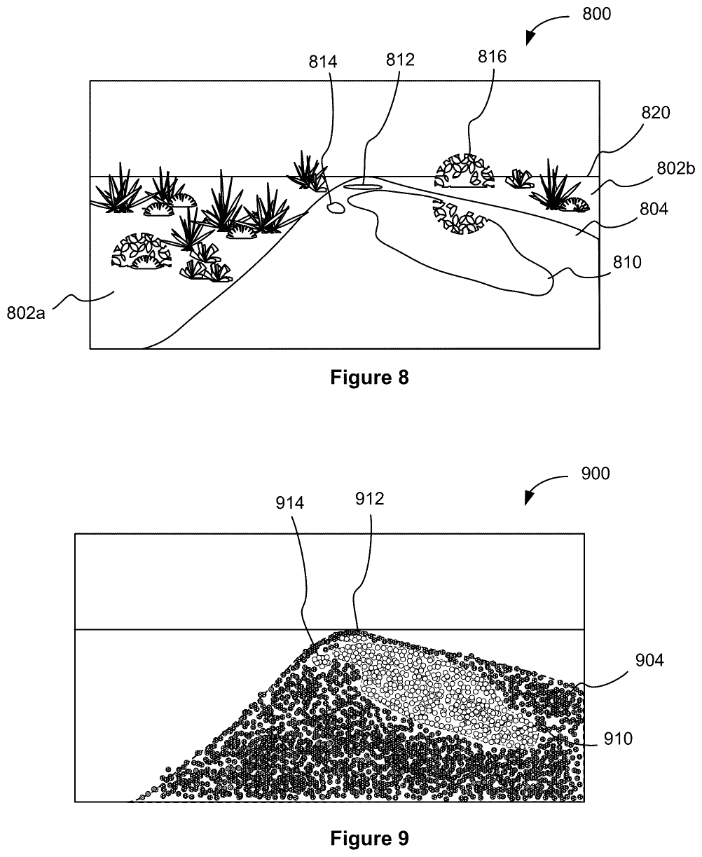

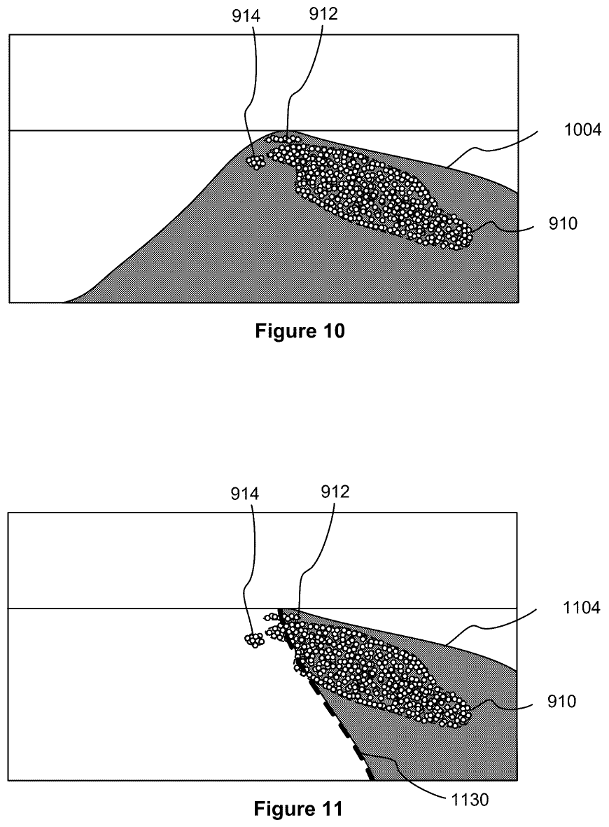

FIGS. 1-5 describe an example of a lidar system for which causes of blockages may be detected. FIGS. 6 and 7 show examples of a process for detecting an obscurant on an environment surface. FIGS. 7-9 describe an example of a process for determining a cause of a lidar blockage. FIG. 8 shows an example of an environment. FIG. 9 shows an example of a point cloud corresponding to the environment of FIG. 8. FIGS. 10-13 show examples of how a point cloud is analyzed to identify an obscurant on an environment surface. FIG. 14 shows an example of how two frames of lidar data may be compared to identify an obscurant on an environment surface.

FIG. 1 illustrates an example light detection and ranging (lidar) system 100. A lidar system 100 may be referred to as a laser ranging system, a laser radar system, a LIDAR system, a lidar sensor, or a laser detection and ranging (LADAR or ladar) system. A lidar system 100 may include a light source 110, mirror 115, scanner 120, receiver 140, or controller 150 (which may be referred to as a processor). The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. The emitted light passes through a window before reaching any downrange targets or object. The window is used at least in part to protect the lidar system, for example, from environmental elements such as road debris and weather, as further described herein with respect to FIG. 6. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. A relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of light of output beam 125 has a pulse energy of 1 microjoule (pJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

The output beam 125 may include or may be referred to as an optical signal, output optical signal, emitted optical signal, output light, emitted pulse of light, laser beam, light beam, optical beam, emitted beam, transmitted beam of light, emitted light, or beam. The input beam 135 may include or may be referred to as a received optical signal, received pulse of light, input pulse of light, input optical signal, return beam, received beam, received beam of light, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

A receiver 140 may receive or detect photons from input beam 135 and produce one or more representative electrical signals. For example, the receiver 140 may produce an output electrical signal 145 that is representative of the input beam 135, and the electrical signal 145 may be sent to controller 150. A receiver 140 or controller 150 may include a processor, a computer system, an ASIC, an FPGA, or other suitable computing circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T may represent a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. A s another example, if a time of flight is measured to be T=1.33 μs, then the distance from the target 130 to the lidar system 100 may be determined to be approximately D=199.5 m. A distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

A light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses of light with a pulse duration of approximately 1-5 ns. As another example, light source 110 may be a pulsed laser that produces pulses of light at a pulse repetition frequency of approximately 100 kHz to 10 MHz or a pulse period (e.g., a time between consecutive pulses of light) of approximately 100 ns to 10 ps. The pulse period T may be related to the pulse repetition frequency (PRF) by the expression τ=1/PRF. For example, a pulse period of 1.33 μs corresponds to a PRF of approximately 752 kHz. Light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 ps. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

A light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. A n output beam 125 may include optical pulses with any suitable pulse energy or peak optical power. As an example, output beam 125 may include pulses with a pulse energy of approximately 0.01 J, 0.1 pJ, 0.5 pJ, 1 pJ, 2 pJ, 10 pJ, or 100 pJ, or any other suitable pulse energy. As another example, output beam 125 may include pulses with a peak power of approximately 10 W, 100 W, 1 kW, 5 kW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PR F) and pulse energy by the expression Pₐᵥ=PRF·E. For example, if the pulse repetition frequency is 500 kHz, then the average power of an output beam 125 with 1-μJ pulses is approximately 0.5 W.

A light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. A light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

A light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. A n optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. A s another example, light source 110 may include a seed laser diode followed by a SOA, which in turn is followed by a fiber-optic amplifier. For example, the seed laser diode may produce relatively low-power seed pulses which are amplified by the SOA, and the fiber-optic amplifier may further amplify the optical pulses.

A light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

A light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (N d) ions, and the gain medium may be referred to as a Nd:YAG crystal. A D PSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a D PSS laser may be an actively Q-switched laser that includes an active Q-switch (e.g., an acousto-optic modulator or an electro-optic modulator). A passively or actively Q-switched D PSS laser may produce output optical pulses that form an output beam 125 of a lidar system 100.

A n output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

A lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

A lidar system 100 may include a telescope, one or more lenses, or one or more mirrors configured to expand, focus, collimate, or steer the output beam 125 or the input beam 135 to a desired beam diameter or divergence. As an example, the lidar system 100 may include one or more lenses to focus the input beam 135 onto a photodetector of receiver 140. A s another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. A s illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

The mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

A lidar system 100 may include a scanner 120 configured to scan an output beam 125 across a field of regard of the lidar system 100. As an example, scanner 120 may include one or more scan mirrors configured to pivot, rotate, oscillate, or move in an angular manner about one or more rotation axes. The output beam 125 may be reflected by a scan mirror, and as the scan mirror pivots or rotates, the reflected output beam 125 may be scanned in a corresponding angular manner. As an example, a scan mirror may be configured to periodically pivot back and forth over a 30-degree range, which results in the output beam 125 scanning back and forth across a 60-degree range (e.g., a O-degree rotation by a scan mirror results in a 20-degree angular scan of output beam 125).

A scan mirror (which may be referred to as a scanning mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (M E M S) device, or any other suitable actuator or mechanism. As an example, a scanner 120 may include a scan mirror attached to a galvanometer scanner configured to pivot back and forth over a 1° to 30° angular range. A s another example, a scanner 120 may include a scan mirror that is attached to or is part of a M E M S device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

A scanner 120 may be configured to scan an output beam 125 (which may include at least a portion of the light emitted by light source 110) across a field of regard of a lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scan mirror that rotates over a 30-degree range may produce an output beam 125 that scans across a 60-degree range (e.g., a 60-degree FOR). A lidar system 100 may have a FOR of approximately 10°, 20°, 40°, 60°, 120°, 360°, or any other suitable FOR.

A scanner 120 may be configured to scan an output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. A scanner 120 may include a first scan mirror and a second scan mirror, where the first scan mirror directs the output beam 125 toward the second scan mirror, and the second scan mirror directs the output beam 125 downrange from the lidar system 100. A s an example, the first scan mirror may scan the output beam 125 along a first direction, and the second scan mirror may scan the output beam 125 along a second direction that is different from the first direction (e.g., the first and second directions may be approximately orthogonal to one another, or the second direction may be oriented at any suitable non-zero angle with respect to the first direction). A s another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. A scanner 120 may be referred to as a beam scanner, optical scanner, or laser scanner.

One or more scan mirrors may be communicatively coupled to a controller 150 which may control the scan mirror(s) so as to guide the output beam 125 in a desired direction downrange or along a desired scan pattern. A scan pattern may refer to a pattern or path along which the output beam 125 is directed. As an example, scanner 120 may include two scan mirrors configured to scan the output beam 125 across a 600 horizontal FOR and a 200 vertical FOR. The two scan mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

A lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). A scanner 120 may include a solid-state scanner and a mechanical scanner. For example, a scanner 120 may include an optical phased array scanner configured to scan an output beam 125 in one direction and a galvanometer scanner that scans the output beam 125 in an approximately orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

A lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may include or may be referred to as a photoreceiver, optical receiver, optical sensor, detector, photodetector, or optical detector. A lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. A s another example, receiver 140 may include one or more avalanche photodiodes (APDs) or one or more single-photon avalanche diodes (SPADs). A s another example, receiver 140 may include one or more PN photodiodes (e.g., a photodiode structure formed by a p-type semiconductor and a n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may receive an input beam 135 that includes an optical pulse, and the detector may produce a pulse of electrical current that corresponds to the received optical pulse. A detector may have an active region or an avalanche-multiplication region that includes silicon, germanium, InGaAs, indium aluminum arsenide (InAlAs), InAsSb (indium arsenideantimonide), AlAsSb (aluminum arsenideantimonide), AlInAsSb (aluminum indium arsenide antimonide), or silicon germanium (SiGe). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

A receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a photocurrent (e.g., a pulse of current produced by an APD in response to a received optical pulse) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

A controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. One or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to another computing system located elsewhere within the lidar system 100 or outside the lidar system 100. A controller 150 may include any suitable arrangement or combination of logic circuitry, analog circuitry, or digital circuitry.

A controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. The frequency, period, duration, pulse energy, peak power, average power, or wavelength of the optical pulses produced by light source 110 may be adjusted based on instructions, a control signal, or trigger pulses provided by controller 150. A controller 150 may be coupled to light source 110 and receiver 140, and the controller 150 may determine a time-of-flight value for an optical pulse based on timing information associated with a time when the pulse was emitted by light source 110 and a time when a portion of the pulse (e.g., input beam 135) was detected or received by receiver 140. A controller 150 may include circuitry that performs signal amplification, sampling, filtering, signal conditioning, analog-to-digital conversion, time-to-digital conversion, pulse detection, threshold detection, rising-edge detection, or falling-edge detection.

A lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. An operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100.

A lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. Some examples of point clouds are shown in FIGS. 10A-11B. As an example, a point cloud may cover a field of regard that extends 600 horizontally and 15° vertically, and the point cloud may include a frame of 100-2000 pixels in the horizontal direction by 4-400 pixels in the vertical direction.

A lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). A point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

A lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. A II or part of a target 130 being contained within a FOR of the lidar system 100 may refer to the FOR overlapping, encompassing, or enclosing at least a portion of the target 130. A target 130 may include all or part of an object that is moving or stationary relative to lidar system 100. A s an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. A target may be referred to as an object.

A lidar system 100 may include a light source 110, scanner 120, and receiver 140 that are packaged together within a single housing, where a housing may refer to a box, case, or enclosure that holds or contains all or part of a lidar system 100. The housing may include a decorative glass or window (not shown), as further described with respect to FIG. 6. A s an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. One or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

A light source 110 may include an eye-safe laser, or lidar system 100 may be classified as an eye-safe laser system or laser product. A n eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. A lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

One or more lidar systems 100 may be integrated into a vehicle. As an example, a truck may include a single lidar system 100 with a 60-degree to 180-degree horizontal FOR directed towards the front of the truck. As another example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. A vehicle may refer to a mobile machine configured to transport people or cargo. For example, a vehicle may include a car used for work, commuting, running errands, or transporting people. A s another example, a vehicle may include a truck used to transport commercial goods to a store, warehouse, or residence. A vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., a drone), or spacecraft. A vehicle may include an internal combustion engine or an electric motor that provides propulsion for the vehicle.

One or more lidar systems 100 may be included in a vehicle as part of an advanced driver assistance system (A DAS) to assist a driver of the vehicle in operating the vehicle. For example, a lidar system 100 may be part of an A DAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle A DAS that provides adaptive cruise control, automated braking, automated parking, collision avoidance, alerts the driver to hazards or other vehicles, maintains the vehicle in the correct lane, or provides a warning if an object or another vehicle is located in a blind spot.

One or more lidar systems 100 may be integrated into a vehicle as part of an autonomous-vehicle driving system. As an example, a lidar system 100 may provide information about the surrounding environment to a driving system of an autonomous vehicle. A n autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

A n autonomous vehicle may be referred to as an autonomous car, driverless car, self-driving car, robotic car, or unmanned vehicle. An autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

An autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

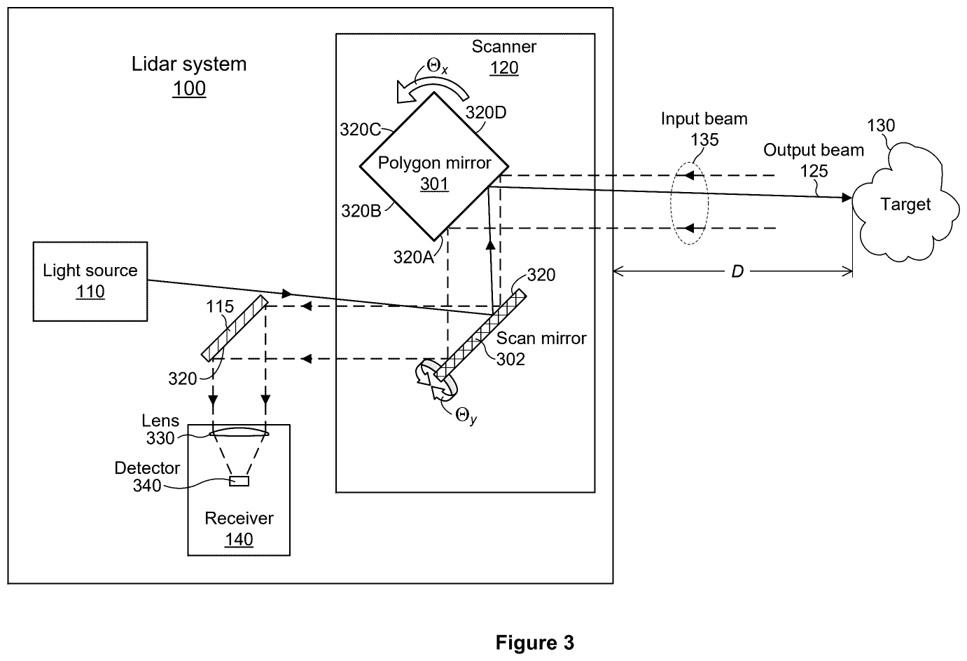

An optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. The distance to a remote target 130 may be determined based on the round-trip time of flight for a pulse of light to travel to the target 130 and back. Alternatively, a lidar system 100 may be configured to operate as a frequency-modulated continuous-wave (FMCW) lidar system and may include a light source 110 that produces a frequency-modulated optical signal. For example, output beam 125 in FIG. 1 or FIG. 3 may include FM light. Additionally, the light source may also produce local-oscillator (LO) light that is frequency modulated. A FMCW lidar system may use frequency-modulated light to determine the distance to a remote target 130 based on a frequency of received light (which includes emitted light scattered by the remote target) relative to a frequency of the LO light. A round-trip time for the emitted light to travel to a target 130 and back to the lidar system may correspond to a frequency difference between the received scattered light and the LO light. A larger frequency difference may correspond to a longer round-trip time and a greater distance to the target 130. The frequency difference between the received scattered light and the LO light may be referred to as a beat frequency.

A light source 110 for a FMCW lidar system may include (i) a direct-emitter laser diode, (ii) a seed laser diode followed by a SOA, (iii) a seed laser diode followed by a fiber-optic amplifier, or (iv) a seed laser diode followed by a SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 10¹⁴ Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of a FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

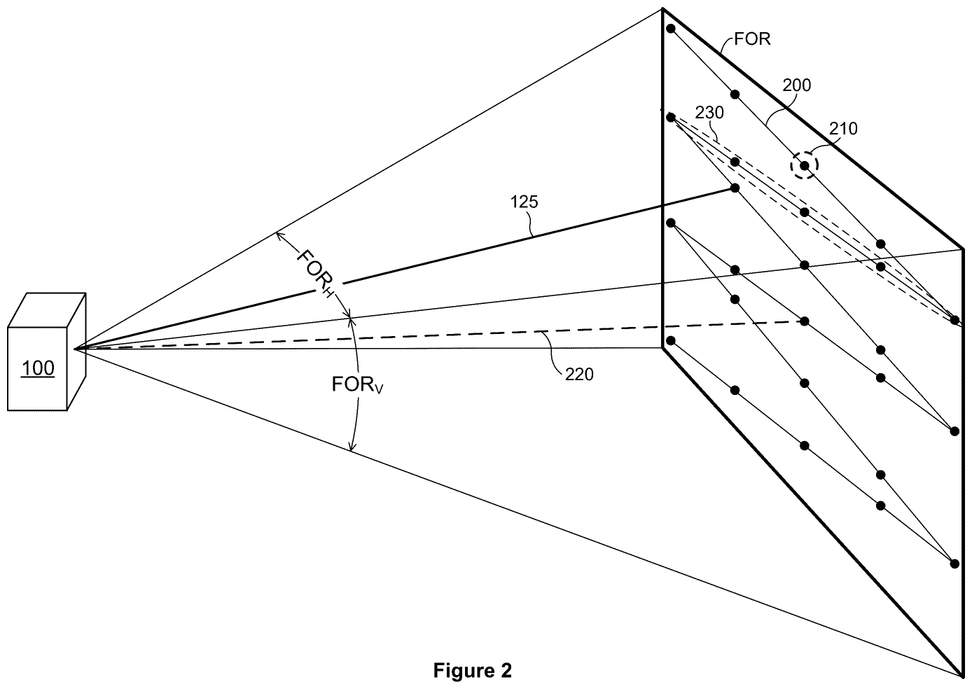

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 by the output beam 125 may correspond to the capture of a single frame or a single point cloud. A scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40°×30°, 90°×40°, or 120°×20°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. A reference line 220 may have any suitable orientation, such as for example, a horizontal angle of 0° (e.g., reference line 220 may be oriented straight ahead) and a vertical angle of 0° (e.g., reference line 220 may have an inclination of 0°), or reference line 220 may have a non-zero horizontal angle or a non-zero inclination (e.g., a vertical angle of +10° or −10°). In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. A n azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

A scan pattern 200 may include multiple pixels 210, and each pixel 210 may be associated with one or more optical pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. A complete cycle or traversal of a scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200.

A pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated pulse of light was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. A n angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). A n angular value may be determined based at least in part on a position of a component of a scanner 120. As an example, an azimuth or altitude value associated with a pixel 210 may be determined from an angular position of one or more corresponding scan mirrors of the scanner 120.

FIG. 3 illustrates an example lidar system 100 with an example rotating polygon mirror 301. A scanner 120 may include a polygon mirror 301 configured to scan output beam 125 along a first direction and a scan mirror 302 configured to scan output beam 125 along a second direction different from the first direction (e.g., the first and second directions may be approximately orthogonal to one another, or the second direction may be oriented at any suitable non-zero angle with respect to the first direction). In the example of FIG. 3, scanner 120 includes two scan mirrors: (1) a polygon mirror 301 that rotates along the Ox direction and (2) a scan mirror 302 that oscillates back and forth along the Oy direction. The output beam 125 from light source 110, which passes alongside mirror 115, is reflected by reflecting surface 320 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. The detector 340 may be a PN photodiode, a PIN photodiode, an APD, a SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R may be greater than or equal to 70%, 80%, 90%, 95%, 98%, or 99%).

A polygon mirror 301 may be configured to rotate along a Ox or Oy direction and scan output beam 125 along a substantially horizontal or vertical direction, respectively. A rotation along a Ox direction may refer to a rotational motion of mirror 301 that results in output beam 125 scanning along a substantially horizontal direction. Similarly, a rotation along a Oy direction may refer to a rotational motion that results in output beam 125 scanning along a substantially vertical direction. In FIG. 3, mirror 301 is a polygon mirror that rotates along the Ox direction and scans output beam 125 along a substantially horizontal direction, and mirror 302 pivots along the Oy direction and scans output beam 125 along a substantially vertical direction. A polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

A polygon mirror 301 may refer to a multi-sided object having reflective surfaces 320 on two or more of its sides or faces. A s an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

A polygon mirror 301 may be continuously rotated in a clockwise or counter-clockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. A n electric motor may be configured to rotate a polygon mirror 301 at a substantially fixed frequency (e.g., a rotational frequency of approximately 1 Hz (or, 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In FIG. 3, the output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. A lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 320 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 320, and then the output beam 125 is directed to the polygon mirror 301, where it is reflected by reflective surface 320A.

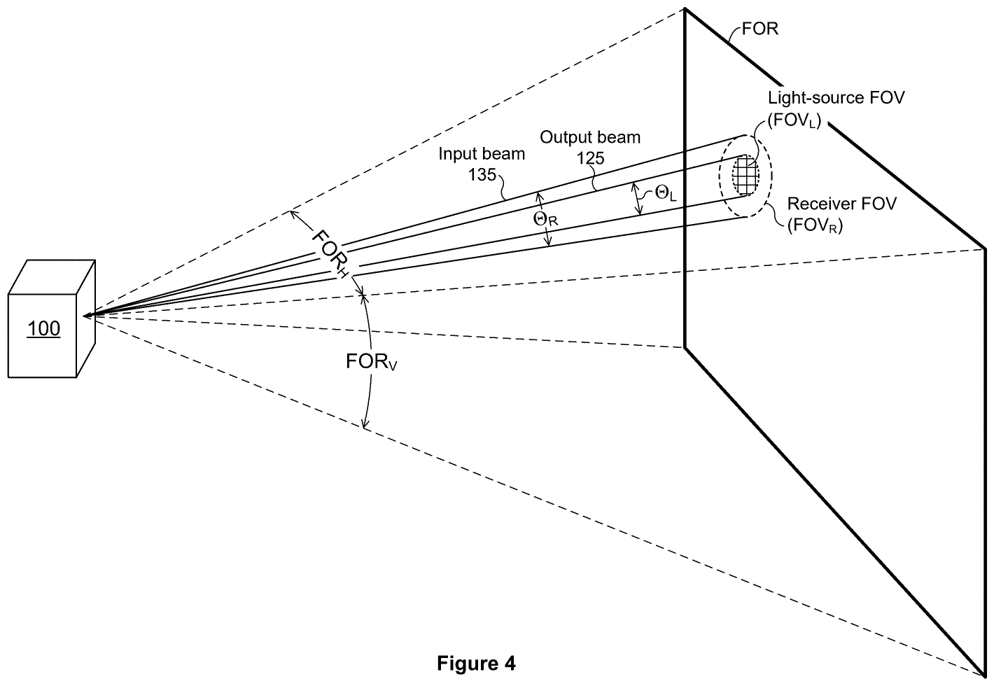

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across afield of regard (FOR). A light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

A scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. The light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. A s an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

An output beam of light 125 emitted by light source 110 may be a collimated optical beam having any suitable beam divergence, such as for example, a full-angle beam divergence Θ_{L} of approximately 0.5 to 10 milliradians (mrad). A divergence Θ_{L} of output beam 125 (which may be referred to as an angular size of the output beam) may correspond to an angular measure of an increase in beam size (e.g., a beam radius or beam diameter) as output beam 125 travels away from light source 110 or lidar system 100. A n output beam 125 may have a substantially circular cross section with a beam divergence characterized by a single divergence value. As an example, an output beam 125 with a circular cross section and a full-angle beam divergence Θ_{L} of 2 mrad may have a beam diameter or spot size of approximately 20 cm at a distance of 100 m from lidar system 100. A n output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

The angular size Θ_{R} of a FOV_{R} may correspond to an angle over which the receiver 140 may receive and detect light. The receiver field of view may be any suitable size relative to the light-source field of view. A s an example, the receiver field of view may be smaller than, substantially the same size as, or larger than the angular size of the light-source field of view. The light-source field of view may have an angular size of less than or equal to 50 milliradians, and the receiver field of view may have an angular size of less than or equal to 50 milliradians. The FOV_{L} may have any suitable angular size Θ_{L}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular size Θ_{R}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. The light-source field of view and the receiver field of view may have approximately equal angular sizes. As an example, Θ_{L} and Θ_{R} may both be approximately equal to 0.5 mrad, 1 mrad, or 2 mrad. Alternatively, the receiver field of view may be larger than the light-source field of view, or the light-source field of view may be larger than the receiver field of view. As an example, OL may be approximately equal to 1 mrad, and Θ_{R} may be approximately equal to 2 mrad. As another example, OR may be approximately L times larger than Θ_{L}, where L is any suitable factor, such as for example, 1.1, 1.2, 1.5, 2, 3, 5, or 10.

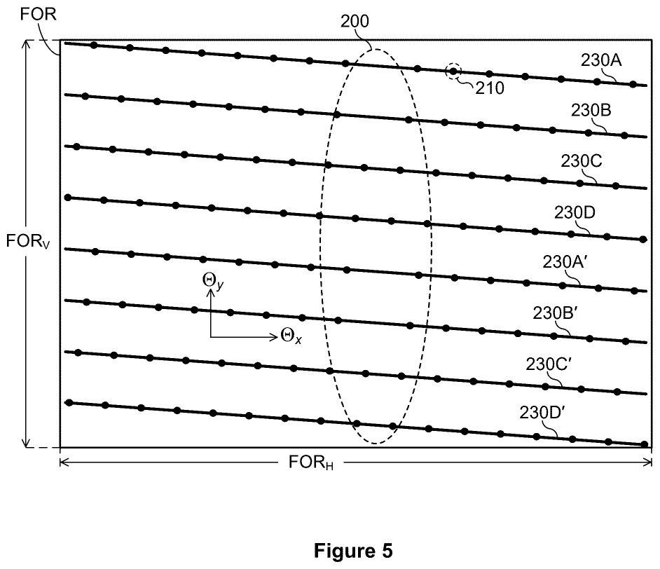

FIG. 5 illustrates an example unidirectional scan pattern 200 that includes multiple pixels 210 and multiple scan lines 230. A scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. A scan pattern 200 in which the scan lines 230 are scanned in two directions (e.g., alternately scanning from right to left and then from left to right) may be referred to as a bidirectional scan pattern 200, and a scan pattern 200 in which the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). Scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. Each scan line 230 in a unidirectional scan pattern 200 may be a separate line that is not directly connected to a previous or subsequent scan line 230.

A unidirectional scan pattern 200 may be produced by a scanner 120 that includes a polygon mirror (e.g., polygon mirror 301 of FIG. 3), where each scan line 230 is associated with a particular reflective surface 320 of the polygon mirror. A s an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. One full revolution of a N-sided polygon mirror may correspond to N successive scan lines 230 of a unidirectional scan pattern 200. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

FIG. 6 is a flow diagram illustrating an embodiment of a process for detecting an obscurant on an environment surface. This process may be implemented on or by a lidar system such as the system 100 of FIG. 1.

In the example shown, the process begins by emitting an output beam comprising pulses of light through a window (602). The output beam may be emitted in the same manner as the examples described with respect to FIGS. 1-5. For example, 1000 beams are emitted 64 times, totaling 64,000 beams.

The process scans the output beam across a field of regard of the system (604). As further described herein with respect to FIGS. 1-5, for each emitted beam, a return signal (sometimes simply called “a return”) is received. At least a portion of the emitted pulses (including empty rays) includes various signal properties such as whether the emitted pulse corresponds to an “empty ray” as further described herein or whether a return (a pulse of light) is received.

The process detects, through the window, received pulses of light corresponding to scattered reflection returns of a first part of the emitted pulses of light, wherein scattered reflection returns, if any, of a second part of the emitted pulses of light are below a detection threshold of the receiver (606). In various embodiments, the detection threshold is a minimum energy level that causes a receiver such as receiver 140 of FIG. 1 to detect a pulse of light. The second part of the emitted beams are also referred to as “empty rays” because they fall below the detection threshold. A n empty ray may be reported by a detector (e.g., firmware) that detects no return or a return below a threshold level. For example, it has been observed that for a lidar with an operating wavelength of 1550 nm, water-based objects tend to absorb light at that wavelength, causing no return beam or an empty ray.

The process determines whether at least a portion of the second part of the emitted pulses of light corresponds to an obscurant on an environment surface (608). For example, the obscurant on the environment surface includes a water-based substance such as a “puddle.” A puddle refers to a pool of water (or, more generally, water-based substance/object) of various sizes and depths. When a vehicle traverses a puddle, this can be uncomfortable for the passenger or even dangerous because the vehicle may skid or hydroplane. Detecting the presence of an obscurant on the environment surface and/or properties of the obscurant may be helpful for downstream processes such as trip planning or wayfinding/navigation.

An obscurant on an environment surface may be detected by fingerprinting returns. Determining a fingerprint or patterns/characteristics of a return allows a target that (at least partially) absorbs the emitted beams to be classified. As further described herein, a classification may indicate the nature of an obscurant on an environment surface such as being a puddle on a road. For example, a contour/shape is created around an environment/ground surface. Empty ray clusters are then identified within the contour. Empty ray clusters from a first point in time are compared with empty ray clusters from a second point in time to determine whether the empty ray clusters changed in a manner that corresponds to detected physical movement of the lidar system or the vehicle associated with the lidar system.

The following figures show an example of how to determine that at least a portion of the second part of the emitted pulses of light corresponds to an obscurant on an environment surface.

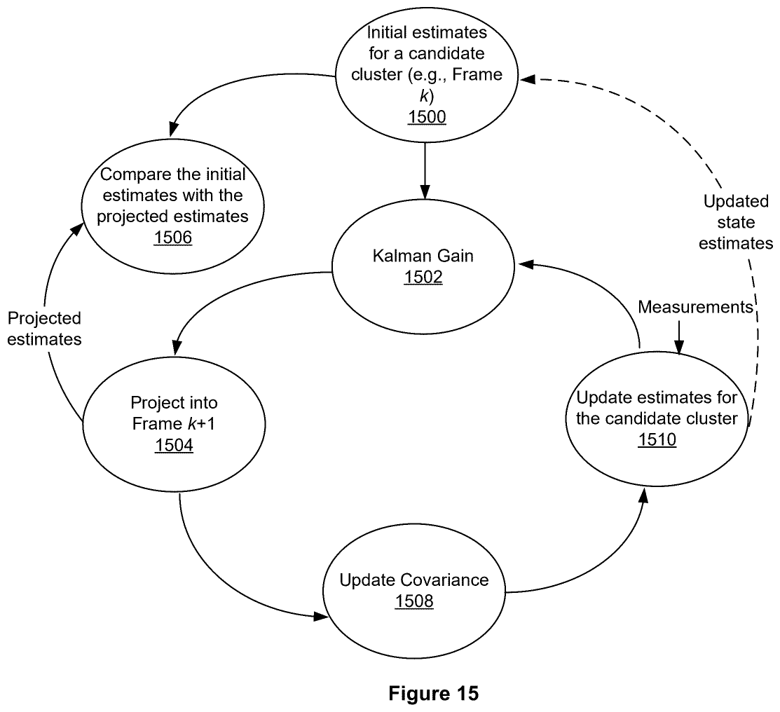

FIG. 7 is a flow diagram illustrating an embodiment of a process for fingerprinting returns to classify absorbing targets. This process may be implemented on or by a processor such as one associated with a lidar system such as the system 100 of FIG. 1 or the processor 1510 shown in FIG. 15. The processor may be included in or local to the lidar system or remote from the lidar system and configured to process data provided by the lidar system. The process may be performed as part of another process, such as part of 608 of FIG. 6.

The disclosed techniques may be applied to a point cloud to detect absorbing obscurants. The point cloud may be generated by a lidar system that scans across a field of regard to generate depth-mapped points as described with respect to FIG. 1. A group of points corresponding to an environment surface may be identified, for example by a geometrical algorithm or a machine learning based algorithm.

In the example shown, the process begins by receiving a new point cloud including a group of points corresponding to the environment surface (702). As described herein, a point cloud refers to a collection of depth-mapped points captured in succession that may be rendered as an image or may be analyzed to identify or detect objects to determine a shape or distance of objects within a field of regard. The received new point cloud refers to the a point cloud that is received at a later point in time compared with a point cloud received at an earlier point in time. The new point cloud and the previously received point cloud may have one or more points that are the same or one or more points that are different. The point cloud may have numerous points that are impossible to process manually, e.g., on the order of 65,000 or 96,000 points. One or more of the points in the point cloud may correspond to an environment surface. For example, a particular point in a point cloud may be classified as an environment surface or not an environment surface.

The environment surface refers to a drivable surface or a ground surface that a vehicle associated with the lidar system may be expected to traverse. For example, the environment surface may include paved asphalt, dirt, sand, grass, etc. The group of points corresponding to the environment surface may be identified in various ways, such as by a geometrical algorithm or machine learning based algorithm. For example, the group of points is determined using various ground estimation techniques.

The process clusters at least a portion of the group of points to form a projected shape approximating at least a portion of the environment surface (704). The projected shape may correspond to an outline of a drivable road for example. The projected shape may be identified based on the projections in the point cloud. Lane markers or other road markings may indicate the boundaries of the road. These markings may be detected by a lidar system because they have increased reflectivity compared with the reflectivity of the rest of the road surface, which is captured by corresponding projections in the point cloud. The projected shape may correspond to an area in which a vehicle associated with the lidar system is expected to travel. As an example, the projected shape includes a lane of travel in one direction but does not include an lane of travel in the opposite direction as further described herein. The projected shape is sometimes referred to as a “drivable road cluster,” “contour,” or “hull.” The “hull” may be concave or convex. A clustering algorithm such as Density-Based Spatial Clustering of Applications with Noise (DBSCAN) may be used. A n example of a projected shape is further described with respect to FIGS. 9 and 10.

The process clusters into an obscurant candidate cluster at least a portion of the second part of the emitted pulses of light that belong to projected locations within the projected shape (706). As described herein, any scattered reflection returns that are below a detection threshold of a receiver of the lidar system may be reported as an empty ray by firmware. One possible cause of a scattered reflection return being below the detection threshold is a substance that absorbs light of the wavelength of the emitted beam. In other words, the scattered reflection returns, if any, of the second part of the emitted pulses of light are below the detection threshold of the receiver due at least in part to absorption at a pre-defined wavelength. In some systems, the pre-defined wavelength tends to be absorbed by a water-based substance so that emitted pulses of light that reach the water-based substance are at least partially absorbed, causing scattered reflection returns to be below the detection threshold.

Clustering identifies empty ray clusters, and a group of empty ray clusters is referred to as an obscurant candidate cluster. The cluster is potentially an obscurant on the environment surface, so it is referred to as a candidate cluster. Processing the cluster by comparing the cluster across point clouds (e.g., between point clouds or frames) as further described herein may confirm whether the obscurant candidate cluster is actually a cluster that corresponds to an obscurant in the environment surface.

A clustering algorithm such as Density-Based Spatial Clustering of Applications with Noise (DBSCAN) may be used. In various embodiments, only those empty rays within the projected shape are clustered and empty rays outside of the projected shape are not processed in this manner. This is because, a vehicle associated with the lidar system is not expected to travel outside of the projected shape (e.g., road surface), so for navigation and similar purposes, the vehicle does not need to avoid puddles outside the possible realm of travel.

The process compares the obscurant candidate cluster with a previously determined obscurant candidate cluster of a previous point cloud to determine whether a detected change from the comparison conforms to a detected physical movement of the system (708). In other words, two point clouds (each corresponding to a different point in time) are compared by comparing a candidate cluster in the first point cloud with a candidate cluster in the second point cloud to determine whether the candidate cluster changes in a way expected for physical movement of the vehicle.

This is sometimes referred to as “target tracking.” Given a detected physical movement of the system, the obscurant candidate cluster is expected to move a particular way. The process determines whether projected locations change from frame to frame in a manner that substantially matches (e.g., within a predefined tolerance) the manner in which an obscurant on the environment surface would move.

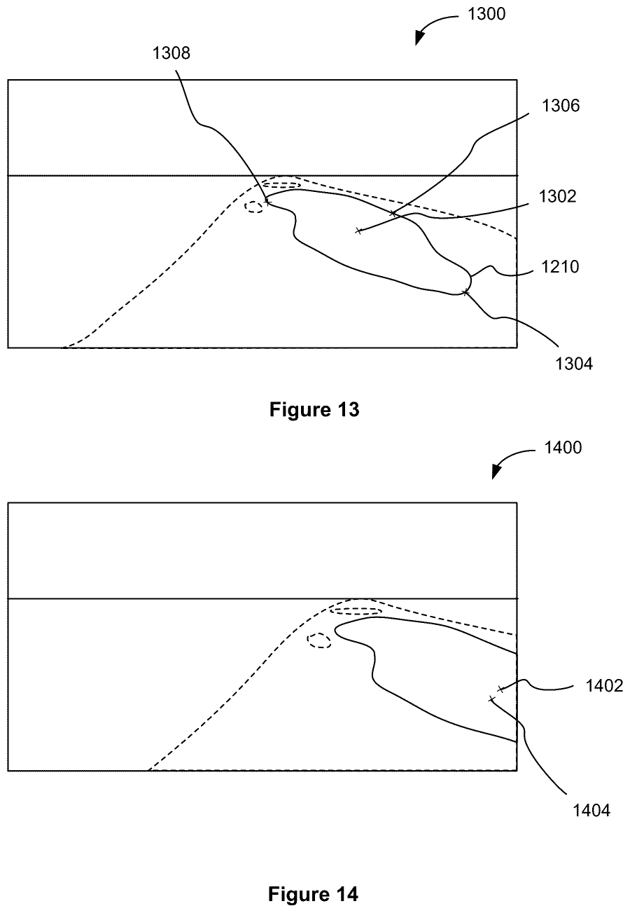

For example, the lidar system 100 of FIG. 1 may include an inertial measurement unit (IMU) or obtain IMU data from an external device (e.g., a vehicle in which the lidar is installed). The IMU measures and reports angular rate and specific force/acceleration experienced by an associated object. The IMU data may be used to determine whether empty rays persist over time/across frames. This indicates a blockage on the window. Suppose the IMU data indicates that a vehicle moves forward, then a cluster of empty rays is expected to move backwards, corresponding to how an obscurant (e.g., a puddle) moves relative to the vehicle as perceived by the lidar system. A s another example, if a vehicle turns, then the shape of the puddle may change significantly and the expected manner in which the shape changes can be modeled/predicted. An example is further described with respect to FIGS. 13 and 14.

As further described with respect to FIG. 14, a linear estimator such as a Kalman filter may be used to track a centroid of a shape and, optionally, other features.

In various embodiments, the detected physical movement of the system includes at least one of: an instantaneous velocity, an instantaneous rotation, or an acceleration. The physical movement may be detected in a variety of ways such as a measurement by an inertial measurement unit (IMU), a global positioning system (GPS), or lidar odometry. A n IMU or GPS may report metrics related to physical movement such as an instantaneous velocity, an instantaneous rotation, or an acceleration or may provide location information at various points in time so that the metrics may be determined from the location information.

Lidar odometry refers to using one or more point clouds to determine metrics such as instantaneous velocity, instantaneous rotation, and acceleration. For example, features are identified in a first point cloud. A process such as simultaneous localization and mapping (SLAM) or lidar odometry and mapping (LOAM) may be performed to identify sharp features and a reference point across a plurality of frames. Then an iterative closest point process (IC P) is performed to fit the observed data associated with the plurality of frames to determine physical movement, e.g., recovering velocity, rotation, and acceleration information.

The process classifies the obscurant candidate cluster as the obscurant on the environment surface in response to a determination that the detected change from the comparison conforms to the detected physical movement of the system (710). For example, the obscurant may be classified as a puddle or not puddle, as potentially problematic for a vehicle or not problematic, etc.

In various embodiments, 704 may be omitted so that the process proceeds directly from 702 to 706. This would cause empty rays to be identified on both the drivable road surface and outside of the drivable road. Omitting 704 may cause additional points to be detected. 704 may be performed because points of interest tend to lie within a hull of drivable road points.

The process of FIG. 7 will now be explained with the aid of the following figures.

FIG. 8 shows an example of an obscurant on an environment surface. In this example scene 800, a road (environment surface 804) that is vanishing into the horizon 820 is shown. The area where the vehicle is expected to travel is environment surface 804, which is a road. Outside of this area, there are shrubs and other plants, making those areas unsuitable for travel. Thus, within this scene 800, the space may be classified as environment surface 804 or non-environment surface 802a and 802b (collectively referred to as “802”). A Iso visible in this scene are candidate obscurants 810, 812, and 814, which may be puddles of water. They are referred to as “candidates,” because they might not actually be obscurants. For example, a mirage may cause 812 to appear to be a puddle when in fact it is not a puddle. The puddles 812 and 814 appear relatively small, while puddle 810 is relatively large and includes a reflection of a shrub 816.

FIG. 9 shows an example of a blockage map. This blockage map 900 corresponds to the scene 800 of FIG. 8, and shows areas 910, 912, and 914 with empty rays. Each of these areas correspond to their counterparts (candidates 810, 812, and 814) of FIG. 8. An empty ray is represented by a white circle, while a return beam is represented by a shaded circle. The blockage map may be based on point cloud. In this example, for clarity of illustration, the elements (such as shrubs and plants) outside the environment surface 804 have been removed. For the most part, the road surface 904 has non-zero returns as represented by the shaded circles. However, there are some areas where there might be obscurants (such as puddles on the road). The disclosed techniques may identify whether any of these candidate obscurant clusters are actually obscurants on the environment surface.

A group of points corresponding to the environment surface may be reported or otherwise provided, e.g., by a geometrical algorithm or a machine learning model. For example, the shaded circles of 904 may be reported as a group of points corresponding to the environment surface. The group of points may be clustered (704) to form a projected shape, an example of which is shown in the following figure.

FIG. 10 shows an example of a projected shape obtained in some embodiments. Each of the components are like their counterparts in FIG. 9 unless otherwise described. A projected shape 1004 is represented by the shaded area in this example. For context, empty ray clusters 910, 912, and 914 are shown in FIGS. 10 and 11. The projected shape may correspond to a drivable surface or a ground surface. The area outside of shape 1004 is not a drivable surface because there are shrubs and other plants as shown in FIG. 8.

As described herein, the projected shape may correspond to an area in which a vehicle associated with the lidar system is expected to travel. For example, the projected shape includes a lane of travel in one direction but does not include a lane of travel in the opposite, as shown in the following figure.

FIG. 11 shows an example of another projected shape obtained in some embodiments. Each of the components are like their counterparts in FIG. 10 unless otherwise described. In this example, the projected shape 1104 is smaller because this road is a two-lane road divided by lane marker 1130. By contrast, the road in FIG. 10 is a one-lane road.

In a two-lane road, the opposite side, while visible, might not be of interest because a vehicle associated with a lidar system configured to perform the disclosed techniques is not expected or permitted to drive on the opposite side. The identification of what is the “environment surface” may include the relevant lane of travel without including lanes in which the direction of travel is opposite of or otherwise different from the vehicle's direction of travel.

In this example, there is a lane marker 1130 that divides the road into two lanes, where the right side is the direction of travel of a vehicle associated with a lidar system configured to perform the disclosed techniques. The left lane has an opposite direction of travel, so the vehicle is not expected to travel in that area. Thus, the projected shape in this example is 1104, which encompasses only the appropriate lane of travel and not the lane of travel in the opposite direction. As further described herein, empty rays outside of the projected shape such as cluster 914 is not of interest and does not need to be processed. In various embodiments, identifying the projected shape and processing only those empty ray clusters that lie within the projected shape therefore improves the functioning of the computer and the technical field of lidar detection because fewer processing resources are used to identify obscurants on an environment surface.

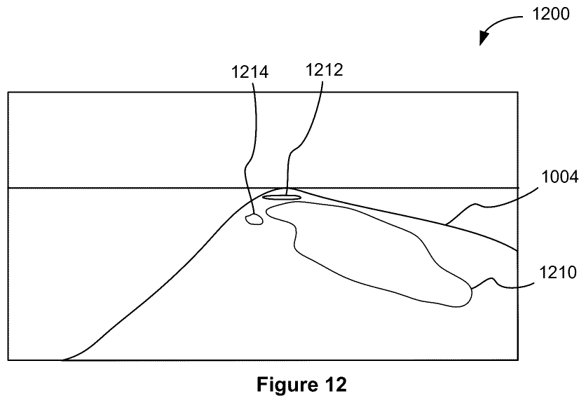

FIG. 12 shows an example of an obscurant candidate cluster obtained in some embodiments. In this example 1200, three obscurant candidate clusters are identified by performing 706 of FIG. 7, e.g., clustering at least a portion of the second part of the emitted pulses of light that belong to the projected locations within the projected shape 1004. For clarity of illustration, the outline of each cluster is shown rather than the individual points that make up the cluster.

For purposes of illustration, the processing of only one of the candidate obscurants 1210 will described in the following figures, but this is not intended to be limiting as the disclosed techniques may be applied to each of 1210, 1212, and 1214 to determine whether each of the candidate clusters are obscurants on the environment surface 1004.

FIG. 13 shows an example of an obscurant candidate cluster in a first frame obtained in some embodiments. In this example 1300, candidate obscurant cluster 1210 is processed according to 708 of FIG. 7 to enable the cluster 1210 to be compared with other candidate clusters. For example, a centroid 1302 and one or more features 1304, 1306, and 1308 are identified. For example, features may be indicated by one or more principal components.

In various embodiments, a detected change includes a change in at least one of: a shape, a size, or a location of the obscurant candidate cluster. The centroid and, optionally, one or more other features enables the position of the candidate cluster to be tracked. For example, recording coordinates of a centroid indicates whether the position of the centroid changes over time. The position of one or more features allows the dimension of the candidate cluster to be measured and to observe whether the dimension grows or shrinks. This may be compared with an expected position and/or change in dimension of the candidate cluster due to measured physical movement of the vehicle.

A current obscurant candidate cluster is compared with a previously determined obscurant candidate cluster of a previous point cloud to determine whether a detected change from the comparison conforms to a detected physical movement of the system. The next figure shows an example of an obscurant candidate cluster in a frame subsequent to the frame shown in FIG. 13.

FIG. 14 shows an example of an obscurant candidate cluster in a second frame obtained in some embodiments. Comparing the obscurant candidate cluster of FIG. 13 and the one of FIG. 14 is an example of how 708-712 may be performed. For example, performing the comparison of the obscurant candidate cluster with the previously determined obscurant candidate cluster of the previous point cloud includes determining a modeled obscurant cluster based at least on the previously determined obscurant candidate cluster of the previous point cloud and the detected physical movement of the system. The modeled obscurant cluster includes at least one of: an expected shape, an expected size, or an expected position. Then, the detected change is determined based at least on comparing the modeled obscurant cluster with the obscurant candidate cluster. Finally, in response to the detected change meeting a threshold, the comparison is determined to conform to the detected physical movement of the system.

FIG. 13 and FIG. 14 may represent adjacent frames (or, more generally, frames that are relatively close) of video data. The previous point cloud 1200 corresponds to a first frame of video data and the new point cloud 1300 corresponds to a second frame of video data. The first frame of video data is earlier in time than the second frame of video data.

In various embodiments, the comparison of the obscurant candidate cluster with the previously determined obscurant candidate cluster of the previous point cloud to determine whether the detected change from the comparison conforms to the detected physical movement of the system (708) is performed for a threshold number of frames. By way of non-limiting example, the threshold number of frames is four frames. Selecting the threshold number of frames may affect the level of confidence in the classification. The classification of the obscurant candidate cluster as the obscurant on the environment surface (712) is based at least on the detected change conforming to the detected physical movement of the system for the threshold number of frames. If the change conforms to the detected physical movement (which may be a quantification or degree of conformity), then the obscurant is determined to be on the environment surface. Otherwise, if the change does not conform to the detected physical movement (e.g., below a threshold of conformity), then the obscurant is determined to not be on the environment surface, e.g., the obscurant may be on the windshield.

Referring to FIG. 14, an observed centroid 1402 and an expected centroid 1404 centroid are shown. If 1402 and 1404 are within a threshold distance of each other, then the detected change conforms to the detected physical movement of the system. Although not shown, similarly 1302 and 1304 may be used to define a threshold of how the shape may change.

In various embodiments, the classification of the obscurant candidate cluster as the obscurant on the environment surface (712) is based at least on a negative confirmation, the negative confirmation indicating the obscurant candidate cluster is associated with an obscurant on a window of the system rather than an obscurant on an environment surface. A n example of negative confirmation is that raindrops are random.

For example, raindrops may be target tracked on the window. The process takes into account expected movement of a window. For example, raindrops tend to roll down the windshield unless there is sufficient velocity/wind and then the raindrops may roll up the windshield. Raindrops are obscurants on the window and not an obscurant on the environment surface, i.e., not a puddle. By contrast, an example of positive confirmation is that a puddle is not likely to change size.

A classification may be based on historical information or tracking over time. For example, snow melting may be tracked with a boolean to improve classification and distinguish from free space loss. For example, an empty return is less likely due to free space loss if the corresponding area in a previous frame (e.g., N frames ago as determined by a tracker) had an absorbing target such as ice. A tracker may model how the target (e.g., snow) is expected to change over time. For example, the area of empty rays may decrease over time because the snow is expected to melt in a certain way.

Depending on the capabilities of the lidar system, the process may determine additional information about the obscurant or may make predictions about the obscurant in different ways. For example, if a lidar system uses two or more wavelengths or if two or more lidar systems are used, two separate sets of lidar data (e.g., output, result, etc.) may be combined.

FIG. 15 shows an example of using a Kalman filter to perform a comparison of an obscurant candidate cluster with a previously determined obscurant candidate cluster. The K alman filter may be used to track at least one feature of the obscurant candidate cluster associated with a dimension of the obscurant candidate cluster.

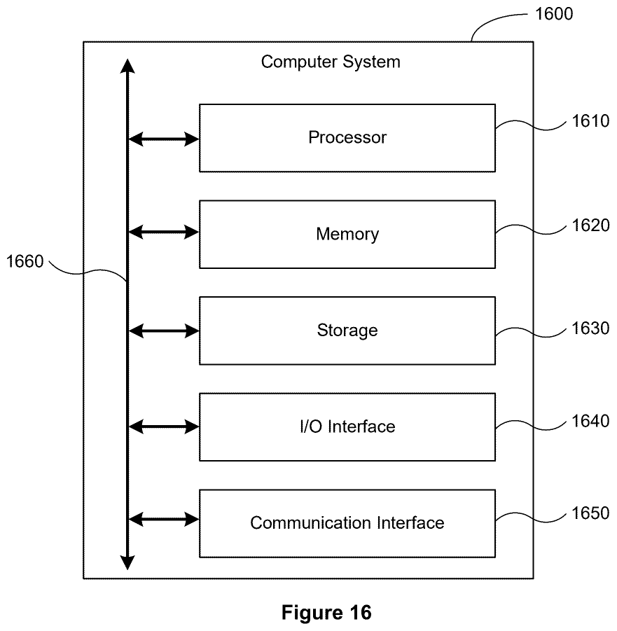

FIG. 16 illustrates an example computer system 1600. One or more computer systems 1600 may perform one or more steps of one or more methods described or illustrated herein. One or more computer systems 1600 may provide functionality described or illustrated herein. Software running on one or more computer systems 1600 may perform one or more steps of one or more methods described or illustrated herein or may provide functionality described or illustrated herein. A computer system may be referred to as a processor, a controller, a computing device, a computing system, a computer, a general-purpose computer, or a data-processing apparatus. For example, controller 150 in FIG. 1 may be referred to or may include a computer system. Herein, reference to a computer system may encompass one or more computer systems, where appropriate.

Computer system 1600 may take any suitable physical form. As an example, computer system 1600 may be an embedded computer system, a system-on-chip (SOC), an application-specific integrated circuit (ASIC), a field-programmable gate array (FPGA), a single-board computer system (SBC), a desktop computer system, a laptop or notebook computer system, a mainframe, a mesh of computer systems, a server, a tablet computer system, or any suitable combination of two or more of these. As another example, all or part of computer system 1600 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 1600 may include one or more computer systems 1600; be unitary or distributed; span multiple locations; span multiple machines; span multiple data centers; or reside in a cloud, which may include one or more cloud components in one or more networks. Where appropriate, one or more computer systems 1600 may perform without substantial spatial or temporal limitation one or more steps of one or more methods described or illustrated herein. As an example, one or more computer systems 1600 may perform in real time or in batch mode one or more steps of one or more methods described or illustrated herein. One or more computer systems 1600 may perform at different times or at different locations one or more steps of one or more methods described or illustrated herein, where appropriate.

As illustrated in the example of FIG. 16, computer system 1600 may include a processor 1610, memory 1620, storage 1630, an input/output (I/O) interface 1640, a communication interface 1650, or a bus 1660. Computer system 1600 may include any suitable number of any suitable components in any suitable arrangement.

Processor 1610 may include hardware for executing instructions, such as those making up a computer program. As an example, to execute instructions, processor 1610 may retrieve (or fetch) the instructions from an internal register, an internal cache, memory 1620, or storage 1630; decode and execute them; and then write one or more results to an internal register, an internal cache, memory 1620, or storage 1630. A processor 1610 may include one or more internal caches for data, instructions, or addresses. Processor 1610 may include any suitable number of any suitable internal caches, where appropriate. As an example, processor 1610 may include one or more instruction caches, one or more data caches, or one or more translation lookaside buffers (TLBs). Instructions in the instruction caches may be copies of instructions in memory 1620 or storage 1630, and the instruction caches may speed up retrieval of those instructions by processor 1610. Data in the data caches may be copies of data in memory 1620 or storage 1630 for instructions executing at processor 1610 to operate on; the results of previous instructions executed at processor 1610 for access by subsequent instructions executing at processor 1610 or for writing to memory 1620 or storage 1630; or other suitable data. The data caches may speed up read or write operations by processor 1610. The TL Bs may speed up virtual-address translation for processor 1610. Processor 1610 may include one or more internal registers for data, instructions, or addresses. Processor 1610 may include any suitable number of any suitable internal registers, where appropriate. Where appropriate, processor 1610 may include one or more arithmetic logic units (ALUs); may be a multi-core processor; or may include one or more processors 1610.

Memory 1620 may include main memory for storing instructions for processor 1610 to execute or data for processor 1610 to operate on. As an example, computer system 1600 may load instructions from storage 1630 or another source (such as, for example, another computer system 1600) to memory 1620. Processor 1610 may then load the instructions from memory 1620 to an internal register or internal cache. To execute the instructions, processor 1610 may retrieve the instructions from the internal register or internal cache and decode them. During or after execution of the instructions, processor 1610 may write one or more results (which may be intermediate or final results) to the internal register or internal cache. Processor 1610 may then write one or more of those results to memory 1620. One or more memory buses (which may each include an address bus and a data bus) may couple processor 1610 to memory 1620. Bus 1660 may include one or more memory buses. One or more memory management units (MMUs) may reside between processor 1610 and memory 1620 and facilitate accesses to memory 1620 requested by processor 1610. Memory 1620 may include random access memory (RAM). This RAM may be volatile memory, where appropriate. Where appropriate, this RAM may be dynamic RAM (DRAM) or static RAM (SRAM). Memory 1620 may include one or more memories 1620, where appropriate.

Storage 1630 may include mass storage for data or instructions. As an example, storage 1630 may include a hard disk drive (HDD), a floppy disk drive, flash memory, an optical disc, a magneto-optical disc, magnetic tape, or a Universal Serial Bus (USB) drive or a combination of two or more of these. Storage 1630 may include removable or non-removable (or fixed) media, where appropriate. Storage 1630 may be internal or external to computer system 1600, where appropriate. Storage 1630 may be non-volatile, solid-state memory. Storage 1630 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 1630 may include one or more storage control units facilitating communication between processor 1610 and storage 1630, where appropriate. W here appropriate, storage 1630 may include one or more storages 1630.

I/O interface 1640 may include hardware, software, or both, providing one or more interfaces for communication between computer system 1600 and one or more I/O devices. Computer system 1600 may include one or more of these I/O devices, where appropriate. One or more of these I/O devices may enable communication between a person and computer system 1600. As an example, an I/O device may include a keyboard, keypad, microphone, monitor, mouse, printer, scanner, speaker, camera, stylus, tablet, touch screen, trackball, another suitable I/O device, or any suitable combination of two or more of these. A n I/O device may include one or more sensors. W here appropriate, I/O interface 1640 may include one or more device or software drivers enabling processor 1610 to drive one or more of these I/O devices. I/O interface 1640 may include one or more I/O interfaces 1640, where appropriate.

Communication interface 1650 may include hardware, software, or both providing one or more interfaces for communication (such as, for example, packet-based communication) between computer system 1600 and one or more other computer systems 1600 or one or more networks. As an example, communication interface 1650 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 1600 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 1600 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 1600 may communicate using fiber-optic communication based on 100 Gigabit Ethernet (100 GbE), 10 Gigabit Ethernet (10 GbE), or Synchronous Optical Networking (SON ET). Computer system 1600 may include any suitable communication interface 1650 for any of these networks, where appropriate. Communication interface 1650 may include one or more communication interfaces 1650, where appropriate.

Bus 1660 may include hardware, software, or both coupling components of computer system 1600 to each other. As an example, bus 1660 may include an Accelerated Graphics Port (AGP) or other graphics bus, a controller area network (CA N) bus, an Enhanced Industry Standard Architecture (EISA) bus, a front-side bus (FSB), a HYPERTRANSPORT (HT) interconnect, an Industry Standard Architecture (ISA) bus, an IN FIN IBA N D interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 1660 may include one or more buses 1660, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 1600. As an example, computer software may include instructions configured to be executed by processor 1610. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. A s an example, all or part of a module, circuit, system, method, or algorithm disclosed herein may be implemented or performed by a general-purpose single- or multi-chip processor, a digital signal processor (DSP), an ASIC, a F PGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECU RE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The classification or identification of an absorbing obscurant is useful for downstream processes. For example, a pathfinding algorithm that plans the path of a vehicle may sense that there are no return beams in a portion of the field of regard, and does not know if this is due to an obscurant on the window or a puddle on the ground. The classification identifies that the cause of the empty rays is an obscurant on the environment surface rather than another cause such as an obscurant on the window. For example, if the cause of the empty rays is a puddle, then the pathfinding algorithm could reroute their path around this puddle.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a light source configured to emit an output beam comprising pulses of light through a window;
s a scanner configured to scan the output beam across a field of regard of the system;
a receiver configured to detect, through the window, received pulses of light corresponding to scattered reflection returns of a first part of the emitted pulses of light, wherein scattered reflection returns, if any, of a second part of the emitted pulses of light are below a detection threshold of the receiver; and
a processor configured to determine whether at least a portion of the second part of the emitted pulses of light corresponds to an obscurant on an environment surface including by being configured to:
receive a new point cloud including a group of points corresponding to the environment surface;
cluster at least a portion of the group of points to form a projected shape approximating at least a portion of the environment surface;
cluster into an obscurant candidate cluster at least a portion of the second part of the emitted pulses of light that belong to projected locations within the projected shape;
compare the obscurant candidate cluster with a previously determined obscurant candidate cluster of a previous point cloud to determine whether a detected change from the comparison conforms to a detected physical movement of the system; and
in response to a determination that the detected change from the comparison conforms to the detected physical movement of the system, classify the obscurant candidate cluster as the obscurant on the environment surface.

2. The system of claim 1, wherein the obscurant on the environment surface includes a water-based substance.

3. The system of claim 1, wherein the group of points corresponding to the environment surface is identified by a geometrical algorithm.

4. The system of claim 1, wherein the group of points corresponding to the environment surface is identified using a machine learning model.

5. The system of claim 1, wherein the projected shape includes a drivable surface.

6. The system of claim 1, wherein the projected shape includes a ground surface.

7. The system of claim 1, wherein the scattered reflection returns, if any, of the second part of the emitted pulses of light are below the detection threshold of the receiver due at least in part to absorption at a pre-defined wavelength.

8. The system of claim 7, wherein the pre-defined wavelength corresponds to a water-based substance.

9. The system of claim 1, wherein the detected change includes a change in at least one of: a shape, a size, or a location of the obscurant candidate cluster.

10. The system of claim 1, wherein the detected physical movement of the system includes at least one of: an instantaneous velocity, an instantaneous rotation, or an acceleration.

11. The system of claim 1, wherein the detected physical movement of the system is based at least on a measurement by at least one of: an inertial measurement unit (IMU) or a global positioning system (GPS).

12. The system of claim 1, wherein the detected physical movement of the system is based at least on lidar odometry.

13. The system of claim 1, wherein performing the comparison of the obscurant candidate cluster with the previously determined obscurant candidate cluster of the previous point cloud to determine whether the detected change from the comparison conforms to the detected physical movement of the system includes:
determining a modeled obscurant cluster based at least on the previously determined obscurant candidate cluster of the previous point cloud and the detected physical movement of the system, wherein the modeled obscurant cluster includes at least one of: an expected shape, an expected size, or an expected position;
determining the detected change based at least on comparing the modeled obscurant cluster with the obscurant candidate cluster; and
in response to the detected change meeting a threshold, determining that the comparison conforms to the detected physical movement of the system.

14. The system of claim 1, wherein performing the comparison of the obscurant candidate cluster with the previously determined obscurant candidate cluster of the previous point cloud to determine whether the detected change from the comparison conforms to the detected physical movement of the system includes using a Kalman filter to track a centroid of the obscurant candidate cluster.

15. The system of claim 14, wherein the Kalman filter is used to track at least one feature of the obscurant candidate cluster associated with a dimension of the obscurant candidate cluster.

16. The system of claim 1, wherein the previous point cloud corresponds to a first frame of is video data and the new point cloud corresponds to a second frame of video data, the first frame of video data being earlier in time than the second frame of video data.

17. The system of claim 1, wherein:
the comparison of the obscurant candidate cluster with the previously determined obscurant candidate cluster of the previous point cloud to determine whether the detected change from the comparison conforms to the detected physical movement of the system is performed for a threshold number of frames; and
the classification of the obscurant candidate cluster as the obscurant on the environment surface is based at least on the detected change conforming to the detected physical movement of the system for the threshold number of frames.

18. The system of claim 1, wherein the classification of the obscurant candidate cluster as the obscurant on the environment surface is based at least on a negative confirmation, the negative confirmation indicating the obscurant candidate cluster is associated with an obscurant on a window of the system.

19. A method, comprising:
emitting an output beam comprising pulses of light through a window;
scanning the output beam across a field of regard of the system;
detecting, through the window, received pulses of light corresponding to scattered reflection returns of a first part of the emitted pulses of light, wherein scattered reflection returns, if any, of a second part of the emitted pulses of light are below a detection threshold of the receiver; and
determining whether at least a portion of the second part of the emitted pulses of light corresponds to an obscurant on an environment surface including by:
receiving a new point cloud including a group of points corresponding to the environment surface;
clustering at least a portion of the group of points to form a projected shape approximating at least a portion of the environment surface;
clustering into an obscurant candidate cluster at least a portion of the second part of the emitted pulses of light that belong to projected locations within the projected shape;
comparing the obscurant candidate cluster with a previously determined obscurant candidate cluster of a previous point cloud to determine whether a detected change from the comparison conforms to a detected physical movement of the system; and
in response to a determination that the detected change from the comparison conforms to the detected physical movement of the system, classifying the obscurant candidate cluster as the obscurant on the environment surface.

20. A computer program product embodied in a non-transitory computer readable medium and comprising computer instructions for:
emitting an output beam comprising pulses of light through a window;
scanning the output beam across a field of regard of the system;
detecting, through the window, received pulses of light corresponding to scattered reflection returns of a first part of the emitted pulses of light, wherein scattered reflection returns, if any, of a second part of the emitted pulses of light are below a detection threshold of the receiver; and
determining whether at least a portion of the second part of the emitted pulses of light corresponds to an obscurant on an environment surface including by:
receiving a new point cloud including a group of points corresponding to the environment surface;
clustering at least a portion of the group of points to form a projected shape approximating at least a portion of the environment surface;
clustering into an obscurant candidate cluster at least a portion of the second part of the emitted pulses of light that belong to projected locations within the projected shape;
comparing the obscurant candidate cluster with a previously determined obscurant candidate cluster of a previous point cloud to determine whether a detected change from the comparison conforms to a detected physical movement of the system; and
in response to a determination that the detected change from the comparison conforms to the detected physical movement of the system, classifying the obscurant candidate cluster as the obscurant on the environment surface.
